(19) United States
(12) Patent Application Publication
(10) Pub. No.: US 2010/0229465 A1
(43) Pub. Date: Sep. 16, 2010

(54) Processed rice hull material as germination and plant growth medium

(75) Inventors: Poul Henrik Ahm, Altea (Alicante) (ES); Dida Maria Ahm, Copenhagen (DK); Louise Charlotte Ahm, Edmonton (CA)

Correspondence Address: THE NATH LAW GROUP, 112 South West Street, Alexandria, VA, 22314, US

(73) Assignee: BENTLE PRODUCTS AG, Baar (CH)

(21) Appl. No.: 12/311,161

(22) PCT Filed: Sep. 21, 2007
(86) PCT No.: PCT/IB2007/004352

§ 371 Date: Mar. 20, 2010

Related U.S. Application Data
(60) Provisional application No. 60/876,136, filed on Dec. 21, 2006.

(30) Foreign Application Priority Data
Sep. 22, 2006 (DK) PA 2006 01222

(51) Int. Cl. A01G 31/00; C05F 11/00; A01G 9/00

(52) U.S. Cl. 47/59 S; 71/23

(57) ABSTRACT

A medium based on rice hull material useful as support for germination and plant growth has been developed. Such material which is effectively devoid of allelopathic substances can be used alone or as an additive. Following, it provides a basis for non-soil germination and plant growth media which are a light material and non-expensive.

### TECHNICAL FIELD

The present invention relates to the fields of germination and plant growth media and germination and plant growth media additives. It is directed to a soil-less rice hull-based medium, its manufacture and use.

### BACKGROUND ART

Texture and composition of soils have a decisive influence on how they provide support for germination and growing of plants. They should keep seeds and roots firmly in place and simultaneously permit new root penetration. The texture should provide for a suitable storage capacity for both water and nutrition that are easy accessible for the growing plants. Furthermore, the soil texture should permit oxygen and general aeration in the root zone to prevent bacterial attack and decomposition of plant parts due to over-watering. Conditions for germination and growing of plants may be improved upon consideration of the soil texture and composition. The soil should posses a quality, which provides a porous soil structure that resists compaction. It is important that the soil have a proper water and nutrition retention capacity and at the same time is able to balance the water/oxygen ratio. The pH should be about neutral, and the soil should be free of pathogens, insects and weeds.

Many materials of both organic as well as synthetic origin have been proposed and used as soil additives in order to improve the soil texture. Examples may be such as e.g.: sphagnum moss, ground bark, leaf mould, expanded mica, peat moss, straw, corn cobs, hydrated tricalcium silicate of small particle size (U.S. Pat. No. 2,780,031; Bryant), vermiculite, expanded perlite (U.S. Pat. No. 3,323,898; Pierce), synthetic resins such as polyacrylonitril and polyvinyl pyrrolidone (U.S. Pat. No. 4,762,545; Youssef et al.))

Plant breeders are, in addition to the generation of healthy plants, also faced with several other challenges. Plant growth media and plant growth media additives should be easily available and as cheap as possible. For example, peat is widely used as an organic horticultural growing media but, environmentally concerned organizations put pressure on the industry to find and to use alternative materials.

For transportation purposes the plant growth media should be as light as possible. As an example such as e.g. the production of rolling-out grass would greatly benefit from a light growth media as large rolls are moved from the field of production to the garden of the customer.

Soil free plant growth media is also desirable in as much as some countries do not permit import of soil containing plants. The avoidance of soil furthermore prevents the spreading of microorganisms, which are present in soil.

It would be highly desirable to provide a good germination and plant growth medium which generates healthy plants and at the same time is also cheap, light, and free of soil.

Rice hulls are the hard shells of rice grains that are removed during the process of preparing edible rice. Rice hulls have a content of silica of about 18 to 22% by weight, and form a porous skeletal silica structure having about 75 to 80% by volume open or void spaces. The content of water makes up about 15% of the rice hull material and the pH is 6.3.

Large volumes of rice hulls are disposed of at great expense by the rice industry either as waste or by burning. Rice hull material in various forms has been described as soil amendment or soil additive for the purpose of improving the texture for growing plants. Examples of such material are: Rice hull ash in substantially amorphous state and having a porous skeletal structure (U.S. Pat. No. 4,707,176; Durham); about 0-25 v/v % whole rice hulls which have aged at least about one year (U.S. Pat. No. 5,114,457; Evans); 0-40 w/w % rice hull compost (U.S. Pat. No. 5,301,466; Egan); 5-25 w/w % ground rice hull (US 2006/0065028 A1; Nudelman); and 95-99 w/w % rice hull ash used for supporting floral arrangements, transporting of fresh cut flowers, and rooting of various plants (U.S. Pat. No. 4,238,374; Durham et al.).

However, the natural content of allelopathic substances (allelochemicals) in rice has prevented the use of rice hull material alone as germination or plant growth media, at least in other plants than rice which are sensitive to inhibition by the allelopathic substances.

Allelopathy is the ability of a plant to release specific chemical substances to its environment whereby the growth of neighbouring plants are either augmented or inhibited. Such plants are known as allelopathic plants and the released substances are called allelopathic substances or allelochemicals. Allelopathic substances include compounds having herbicidal, anti-weed and/or anti-microbial effect.

From an evolutional point of view it seems likely that a purpose of the allelopathic substances is to ensure the growth conditions of the plant in the competition with microorganisms and other plants, especially other plant species. Thus it has been reported that some allelopathic substances from rice, a flavone (5,7,4′-trihydroxy-3′,5′-dimethoxyflavone) and a cyclohexenone (3-isopropyl-5-acetoxycyclohexene-2-one-1) which have been identified to be effective against weeds and fungal pathogens, did not inhibit the rice growth at the same concentrations.

JP 09070223 A (Kitagawa Iron Works Co. Ltd.) uses a pulverized rice hull material having water content adjusted to specified level as a culture medium material for plants. A washing step with addition of a washing liquid and subsequent removal of the wash liquid is not mentioned.

CN 1582622 A (Bai Guijun) treats rice husk by breaking, immersing in water, stirring, spreading, applying water, covering by film, holding water and applying fertilizer to obtain a substrate for dry soilless cultivation of rice seedlings. A washing step with addition of a washing liquid and subsequent removal of the wash liquid is not mentioned. Apparently such washing step is of minor importance when the substrate is used for rice seedlings which are lesser, if at all, inhibited by the alleopathic substances from the rice husk.

JP 01261289 A (Kususe Mikio) treats rice hulls with a solution of sodium hydroxide, potassium hydroxide of sodium hypochlorite for reaction with specific components in the hulls, where after the solution is pressed out and the hulls are left to stand for the reaction to proceed. What happens to possible allelopathic substances is not mentioned. In any case this treatment is rather complicated and based on a chemical treatment which is lesser desirable and is expensive.

According to the experiments made by the inventor seeds of lettuce and broccoli cannot germinate in a rice hull material unless the material has been washed sufficiently to remove alleopathic substances. The above mentioned prior art is silent about the alleopathic substances. This is probably because the prior art germination and plant growth substrates was used for the germination and growth of rice plants or other plants which are not sensitive to the alleopathic substances.

Reported attempts of using rice hull material alone as a germination and plant growth medium for alleopathically sensitive plants has not been successful. It would however be desirable to obtain treated rice hull material which is effectively devoid of germination and plant growth inhibitors and which is cheap, light and free of soil and may be used as sole plant germination and plant growth medium not only to rice but also to non-rice plants which would be inhibited in the presence of the alleopathic substances from rice.

### DISCLOSURE OF THE INVENTION

It has now been found that a germination and plant growth medium usable for germination and growth of plants being sensitive to inhibition by allelopathic substances is obtainable by a simple and non expensive method based on a rice hull material.

Accordingly, the present invention relates to a method of preparing a germination and plant growth medium from a rice hull material usable for germination and growth of plants being sensitive to inhibition by allelopathic substances from rice by processing rice hull material to remove allelopathic substances, wherein the rice hull material is washed with an aqueous wash liquid.

In a preferred embodiment the aqueous wash liquid includes a surfactant.

The invention also relates to a germination and plant growth medium obtained by the inventive method, which medium is sufficiently devoid of allelopathic substances to be usable as a sole medium for germination and growth of plants being sensitive to inhibition by allelopathic substances from rice.

The present invention also relates to a method of preparing processed rice hull material to obtain the medium, wherein said method comprises the steps: a) incubating the rice hull material in an aqueous wash liquid; b) removing the water-based solution partially or completely; and c) optionally, dividing the rice hull material.

Furthermore, the present invention relates to a germination and plant growth medium mat comprising processed rice hull material, wherein said rice hull material supports germination and plant growth even when used as a sole medium.

Moreover, the present invention relates to a method of preparing a germination and plant growth medium mat, comprising the steps of: a) preparing a germination and plant growth medium; b) adding a binder to the germination and plant growth medium of a) to form a blend; c) letting the blend settle on a surface; and d) optionally heating the blend.

The present invention also relates to a germinating unit comprising seeds or the like growth-suited parts of a plant, and which are available either separately or coherently in form of seed tapes, wherein the unit comprises the plant growth medium.

The present invention also relates to a method of preparing a germination unit, comprising the steps: a) preparing the germination and plant growth medium mat; b) optionally, forming said mat into a suitable size; and c) placing a seed in said mat.

The present invention also relates to a seed tape comprising successively arranged germinating units attached to at least one carrier strip wherein said units comprises a seed placed in the germination and plant growth medium.

The present invention also relates to a method of preparing a seed tape, comprising the steps: a) preparing the germination and plant growth medium mat; b) optionally, forming said mat into a size suitable for the carrier strip; c) attaching the mat to the carrier strip; and d) placing a seed in said mat.

Furthermore, the present invention relates to use of a germination and plant growth medium for the production of plants.

Moreover, the present invention relates to use of a germination and plant growth medium for the production of grass mats.

Furthermore, the present invention relates to use of a germination and plant growth medium for the production of germinating units.

Moreover, the present invention relates to use of a germination and plant growth medium for the production of seed tapes.

The extent of applicability of the invention appears from the following detailed description. It should, however, be understood that the detailed description and the specific examples are merely included to illustrate the preferred embodiments, and that various alterations and modifications within the scope of protection will be obvious to persons skilled in the art on the basis of the de-tailed description.

### DETAILED DESCRIPTION OF THE INVENTION

The present invention is described in detail below, For the purpose of interpreting this specification the following definitions shall apply and whenever appropriate, terms used in the singular shall also include the plural and vice versa.

Definitions

“Filler material” as used herein, means the germination and plant growth material that are suitable for use in germinating units of the seed tape.

“Germinating unit” as used herein, means the germinating and plant growth material comprising a seed.

“Seed tape” as used herein, means a successive number of germinating units that are placed in a row on a carrier material.

“Divided rice hull material” as used herein, means that the individual rice hulls are divided in two or more pieces or particles which are more or less fine.

The germination and plant growth medium of the present invention is useful as replacement for soil, peat moss, vermiculite, rock wool, and the like. It may also be used as soil amendment or additive either alone or in combination with other suitable material as mentioned above. Furthermore, it is also useful for integrated growing-systems for cultivation of greenhouse crops such as tomatoes, and the like. Due to environmental reasons there is a search for good alternatives for peat moss which is widely used by commercial plant breeders. Many plant-based materials have been rejected due to the high content of cellulose. Alternatives such as e.g. coconut fibres have been considered, but they are difficult to use due to the uneven texture of the material and variation in the chemical properties.

Rice hull is generated as waste during production of edible rice many places in the world and is consequently obtainable very easily and at a low cost. The generation of processed rice hull material according to the present invention is thus cheap even when it has to go through a cleaning process. The processed rice hull material has a natural low pH at 5.3. This is a low value, but it does not affect the germination in a negative way, on the contrary, such a low pH value may prevent certain dangerous fungi strains or microorganisms from attacking the germinating seed.

In one embodiment the invention relates to a germination and plant growth medium comprising processed rice hull material, wherein said rice hull material supports germination and plant growth when used as a sole medium, and wherein said rice hull material is effectively devoid of allelopathic substances.

In one embodiment the invention relates to a germination and plant growth medium, wherein said rice hull material is selected from divided, whole or essentially whole rice hulls, or a mixture thereof.

The method according to the invention thus optionally further comprises a step for dividing the rice hull material before or after the washing thereof. By dividing before the washing the increased surface area of the rice hulls may improve the removal of alleopathic substances. On the other hand is it more difficult to dry the processed rice hulls. Thus the appropriate time for an optional dividing step may depend on the actual circumstances.

In one embodiment the invention relates to a germination and plant growth medium, wherein said divided rice hull material has a size between 1 μm and 5 mm; 1 μm and 4 mm; 1 μm and 3 mm; 1 μm and 2 mm; or 1 μm and 1 mm.

In one embodiment the invention relates to a germination and plant growth medium, wherein said medium comprises more than 1%, more than 10%, more than 20%, more than 30%, more than 40%, more than 50%, more than 60%, more than 70%, more than 80%, more than 90% or 100% of rice hull material.

In one embodiment the invention relates to a method of preparing processed rice hull material to obtain a germination and plant growth medium, wherein said method comprises a step for washing the rice hull material, and wherein washing is performed in a water-based solution optionally comprising additional agents selected from the group consisting of: organic or inorganic acids, organic or inorganic bases, surfactants and binders. Based on the present experiments it appears to be feasible to use ordinary tap water without any agents added. However this generally requires rather long time for the processing. A preferred additive is a conventional surfactant being able to decrease the surface tension of the aqueous wash liquid. As demonstrated in example 2 this may reduce the processing time significantly, properly due to a better moistening of the rice hull surfaces.

Each step during the preparation may be performed with or without stirring or moving the rice hull material. Sometimes the material may be left to incubate in the container without stirring for the desired length of time alternatively the material is stirred occasionally, at defined intervals, or continuously.

In one embodiment the invention relates to a method of preparing processed rice hull material to obtain a germination and plant growth medium, wherein said method comprises a step for washing the rice hull material, and wherein washing is performed in a water-based solution optionally comprising additional agents selected from the group consisting of: organic or inorganic acids, organic or inorganic bases, surfactants and binders, wherein said water-based solution is selected from hot water, cold water or steam water.

In one embodiment the invention relates to a method of preparing processed rice hull material to obtain a germination and plant growth medium, wherein said method comprises a step for washing the rice hull material, and wherein washing is performed in a water-based solution optionally comprising additional agents selected from the group consisting of: organic or inorganic acids, organic or inorganic bases, surfactants and binders, wherein said inorganic acids are selected from the group containing: HNO₃, H₂SO₄, HCl, HBr, HI and HClO₄.

In one embodiment the invention relates to a method of preparing processed rice hull material to obtain a germination and plant growth medium, wherein said method comprises a step for washing the rice hull material, and wherein washing is performed in a water-based solution optionally comprising additional agents selected from the group consisting of: organic or inorganic acids, organic or inorganic bases, surfactants and binders, wherein said surfactants are selected from the group containing: soap and other conventional tensides.

In one embodiment the invention relates to a method of preparing processed rice hull material to obtain a germination and plant growth medium, wherein said method comprises a step for washing the rice hull material, and wherein washing is performed in a water-based solution optionally comprising additional agents selected from the group consisting of: organic or inorganic acids, organic or inorganic bases, surfactants and binders, wherein said binders are cationic binders selected from the group containing: EDTA and EGTA.

In one embodiment the invention relates to a method of preparing processed rice hull material to obtain a germination and plant growth medium, wherein said method comprises a step for washing the rice hull material, and wherein said method further comprises a step for heating the rice hull material.

The heating may take place both before, during and/or after the washing step. Heating may promote the extraction of allelopathic substances and the removal of the wax layer present on the crude rice hull material.

In one embodiment the invention relates to a method of preparing processed rice hull material to obtain a germination and plant growth medium, wherein said method comprises a step for washing the rice hull material, and wherein said method further comprises a step for heating the rice hull material, and wherein heating is employing temperatures of at least 50° C., at least 60° C., at least 70° C., at least 80° C., at least 90° C. or at least 100° C.

In one embodiment the invention relates to a method of preparing processed rice hull material to obtain a germination and plant growth medium, wherein said method comprises a step for washing the rice hull material, and wherein said method further comprises a step for dividing the rice hull material.

The material may be divided by means of any common available method such as e.g. in a hammer mill, knife mill, depending on the desired size of the rice hull material. The size has implication for e.g. the structure and water retention capacity of the final medium.

In one embodiment the invention relates to a method of preparing processed rice hull material to obtain a germination and plant growth medium, wherein said method comprises a step for washing the rice hull material, and wherein said method further comprises a step for drying the rice hull material subsequent to washing thereof.

Means of drying may be provided by any commonly known methods such as e.g. drip drying; centrifugation; any drying equipment; exposure to any heating source such as e.g. sun light, hot air, micro waves; or any combinations thereof.

In one embodiment the invention relates to a germination and plant growth medium mat comprising processed rice hull material, wherein said rice hull material supports germination and plant growth when used as a sole medium.

Both the germination and plant growth medium and the germination and plant growth medium mat may further comprise other defined substances providing additional germination and growth promoting or favorable effects. Such substances may be selected from the group containing: vermiculite, perlite, zeolite, cellulose materials such as wood fibres or wood powders, sphagnum, clay particles, mineral fibres such as rock wool or the like substances, pesticides, herbicides, insecticides, fungicides, virae, bacteria, fungi such as trichoderma, fungi spores, insect eggs such as predatory nematodes, fertilizers, enzymes, animal repellants, hormones, pH-adjusting agents, binders such as polyvinyl alcohol, polyethylene glycol or other plant-compatible binders, carbon, trace elements such as molybdenum, kiselguhr, surfactants, water absorbing substances such as superabsorbing polymer (SAP), carboxymethyl cellulose (CMC) and silica. Several substances are available in a microencapsulated form which may also be used.

In one embodiment the invention relates to method of preparing a germination and plant growth medium mat, comprising the steps of: a) preparing a germination and plant growth medium; b) adding a binder to the germination and plant growth medium of a) to form a blend; c) letting the blend settle on a surface; and d) optionally heating the blend, wherein the binder is selected from the group consisting of: bi-component fibre, polyvinyl acetate (PVA), water based glue, hot-melt glue and wax.

The bi-component fibres are fibres with a core of polylactide (PLA), polyester (PET), polyethylene (PE) and polypropylene (PP) or the like and an outer sheet or coating of a thermoplastic material having a lower melting temperature than the fibre core. Upon controlled heating the outer sheet of the fibre becomes sticky and establishes bonding between the rice hull material thereby promoting the formation of the germination and plant growth medium mat. The content of bi-component fibre may be between 2-20%, 2-15%, 2-10%, 2-5%, 5-20%, 5-15%, 5-10%, preferably 6% of the total content. The length of the bi-component fibre may be between 1-10 mm, 1-8 mm, 1-6 mm or 1-4 mm.

Increased temperatures may be employed during the preparation of the germination and plant growth medium mat. In some cases the temperature is between 90° C. and 160° C., and in some cases between 130° C. and 150° C. It is apparent to those skilled in the art that the temperature is dependent on the choice of bi-component fibres used.

One method that may be used for preparing the germination and plant growth medium mat of the present invention is to use the air-laid dry forming process described in WO 2005/042859 (Formfiber Denmark; Andersen).

The texture of the rice hull material provides the possibility of using a simple method for preparing the germination and plant growth medium mat. Said mats may be prepared by the sedimentation of the processed rice hull material together with the binder onto a transportable/rotating screen, optionally covered with a thin filter material. The sedimentation may be promoted by engaging suction means under the screen. The mat may be used whole or formed into smaller units. The formation of smaller units may be done by cutting or breaking. Breaking of the mat according to the invention may be assisted by the presence of a groove or tool mark. Such groove may be formed during the sedimentation of the mat material by the presence of separating and distance sheets/plates, which are placed a little above the screen in order to allow the material to connect and form a whole mat comprising grooves.

In one embodiment the invention relates to method of preparing a germination and plant growth medium mat, comprising the steps of: a) preparing a germination and plant growth medium; b) adding a binder to the germination and plant growth medium of a) to form a blend; c) letting the blend settle on a surface; and d) optionally heating the blend, wherein the binder is selected from the group consisting of: bi-component fibre, polyvinyl acetate (PVA), water based glue, hot-melt glue and wax, and wherein the bi-component fibre is selected from the group consisting of: polylactide (PLA), polyester (PET), polyethylene (PE) and polypropylene (PP).

Use of crude unprocessed rice hull material for plant growing as a sole material has not been successful. This may in part be explained by the allelopatic substances (allelochemicals) present in said rice hull material, and partly by the poor water retention capacity due to the water repellent layer of the rice hull material. However, rice hull ashes, aged rice hull, rice hull compost and ground rice hull have been used as soil amendments for the purpose of improving the soil texture.

The germination and plant growth medium comprising processed rice hull material according to the present invention, however, can be used for numerous purposes relating to production of plants. The medium may be used directly as unbound free and/or friable particles or after being formed into mats as described in the present application. For example, when used as an alternative to soil or soil like substances in pots, trays or the like free and/or friable particles may more easily be distributed, whereas for the production of germinating units, seed tapes and the like it may be advantageous to utilize germination and plant growth medium mats according to the invention.

In one embodiment the invention relates to the use of a germination and plant growth medium for the production of plants.

In one embodiment the invention relates to the use of a germination and plant growth medium for the production of germinating units.

In one embodiment the invention relates to the use of a germination and plant growth medium for the production of seed tapes.

The germination and plant growth medium comprising processed rice hull material may be used as filler material in germination units and in seed tapes. Such filler material may be in the form of bulk material or in the form as a mat. Thus the medium may be given any physical form suitable for germination and plant growth selected from a mat, a block, a particulate or granulate, which form may be incorporated in a confined space and/or attached to a carrier tape. The process of preparing germination units and seed tapes have be described in several in patent applications of the present inventor e.g. in U.S. Pat. No. 6,578,317 and U.S. Pat. No. 6,701,664.

In one embodiment the invention relates to the use of a germination and plant growth medium for the production of grass mats.

The processed rice hull material according to the invention can be used for the production of grass mats for golf courses, sport fields and gardens, etc. The grass seeds may be distributed directly into the divided or whole rice hull material or the seeds may be placed into rice hull material mats. Water and fertilizers is added during the period when required. Once the grass roots develop they will penetrate the rice hull material and form a web, making the use of rice hull material mats less important. Finally, when the grass mat has reached the required plant density, it can be formed into suitable lengths and rolled or folded prior to transportation to the place of use. Grass mats grown on soil may need up to 6 month and grass mats grown on peat moss may need up to 2 month before it is ready for transplantation. The grass mats grown in the germination and plant growth medium according to the invention only need about a month before it is ready for transplantation. The time for transplantation is determined by the strength of said grass mats to be rolled and transported to the customer. The grass mats according to the invention may optionally be grown in the presence of a web, which for environmental reasons may be bio degradable. The web provides additional strength to the grass mats and is thereby contributing to a reduction of the time to transplantation.

### EXAMPLES

This invention is now illustrated by the following examples that are not intended to be limiting in any way.

### Example 1

### Preparation of Processed Rice Hull Material

A small amount of water, just enough to make the rice hull material humid was added to divided rice hull material (particle sizes between 0 to 2 mm). After two days of incubation a small aliquot of the soaked rice hull material was taken and washed once in a small amount of tap water after which the material was dried. The procedure was repeated with a two day interval until five samples were obtained.

Sample 1-5 were each placed in separate flat plastic trays, and 25 lettuce and 25 broccoli seeds were seeded into each tray and water was added.

Results: No seeds germinated in sample one, only few seeds germinated in sample two but the seeds in sample three, four and five (soaked in 6, 8 and 10 days, respectively) all germinated.

Accordingly, in a preferred embodiment the processed rice hull material are soaked in water in about 6-8 days. The processed rice hull material used in the examples 3-10 had been processed in this way.

### Example 2

### Preparation of Processed Rice Hull Material Using Surfactant

In a bucket containing 12 L whole rice hull material 2 L surfactant-water solution (0.5 g/l Lisapol®) was added and the material was stirred. After 15 minutes incubation at room temperature water without surfactant was added until the rice hull material was covered. The material was stirred vigorously for 30 seconds. The material was then transferred to a net to drip dry. The net containing the material was centrifuged at 1000 rpm. The humid material was then divided to a size between 0 and 2 mm. The processed rice hull material was distributed on trays in which seeds of cabbage were seeded.

Lisapol®—available from Syngenta—is an alkyl ethoxylate based surfactant which decreases the surface tension.

Results: Cabbage plants were able to grow in surfactant processed rice hull material whereas they did not grow in crude rice hull material and not even if surfactant was added during the watering of the seeds. It can be concluded that the inventive method can be carried out with a satisfactory result in substantially shorter time if the aqueous wash liquid contains a surfactant.

### Example 3

### Use of Processed Rice Hull Material as Germination and Plant Growth Medium—A Comparison with Crude Rice Hull Material

To test other seeds than lettuce and broccoli a germination experiment were carried out using seeds of lettuce (pellets), onions (naked and film-coated), peas (naked), pepper (naked and pellets), cabbage (naked and film-coated), sugar-beet (raw and pellets), tomato (pellets and naked) and gerbera.

Seeds of the above mentioned plants were seeded in either rice hull material processed as stated in example 1 or in crude rice hull material.

Results: All the tested seeds germinated well in the processed rice hull material but did not germinate in crude rice hull material. About 10 litres of processed rice hull material is required for each tomato, pepper and cucumber plant, etc.

### Example 4

### Preparation of Germination and Plant Growth Medium Mats Using Hot Melt as Binder

Divided processed rice hull material according to example 1 was mixed with 4.5% hot melt material obtained from Schaetti, CH. The blend was laid on a surface and placed in a furnace having the temperature at 120° C. The material was allowed to cool and a germination and plant growth medium mat was made.

Seeds of lettuce and broccoli were seeded in the mat and in germinating units/seed tapes using the mat as filler material. In parallel seeds were also seeded in mats made from vermiculite and bi-component fibres as known in the art.

Results: All the tested seeds geminated well. There could be observed no differences in growth between seeds grown in the plant growth medium mat as described above and the vermiculite based mat.

### Example 5

### Preparation of Germination and Plant Growth Medium Mats Using Wax as Binder

Wax with a low melting point obtained from Beyersdorf was placed in the freezer until frozen where after the wax pearls was crunched to powder. 6-7% wax powder was mixed with divided processed rice hull material from example 1. The blend was laid on a surface and placed in a furnace having the temperature at 120° C. The material was allowed to cool and a germination and plant growth medium mat was made.

Seeds of lettuce and broccoli were seeded in the mat and in germinating units/seed tapes using the mat as filler material. In parallel seeds were also seeded in mats made from vermiculite and bi-component fibres as known in the art.

Results: All the tested seeds geminated well. There could be observed no differences in growth between seeds grown in the plant growth medium mat as described above and the vermiculite based mat.

### Example 6

### Preparation of Germination and Plant Growth Medium Mats Using PVA Water Based Glue as Binder

PVA water based glue combined with a special two step gluing technique was tested. For that purpose the processed rice hull material from example 1 didn't needed to be dry. The moist material fresh from the centrifuge (1000 rpm) was used. The first step was to mix about 15% of the material with the PVA glue-suspension TL 7.1 from Stockhausen, DE until all of the material was covered with glue. This part was then mixed carefully with the remaining last 85% of the total portion. After mixing, the material was placed on a sieve, flattened a little, and then dried out by hot air which was blown through the material from above. It worked out quite well. A simple gluing technique as described above can be carried out at high speed and it doesn't require a lot of expensive machinery.

Seeds of lettuce and broccoli were seeded in the mat and in germinating units/seed tapes using the mat as filler material. In parallel seeds were also seeded in mats made from vermiculite and bi-component fibres as known in the art.

Results: All the tested seeds geminated well. There could be observed no differences in growth between seeds grown in the plant growth medium mat as described above and the vermiculite based mat.

### Example 7

### Comparison Between Processed Rice Hull Material and Vermiculite as Growth Media—Drying Out of Plants

Growers often transplant broccoli and lettuce plants into completely dry soil and then leave the plants to dry out and suffer for up to several hours before watering. Lettuce plants initially grown in rice hull or vermiculite were tested how they would survive such conditions.

Seeds of lettuce plants were seeded in vermiculite or in processed rice hull material from example 1. They were grown until each plant had four real leaves.

Two big, flat plastic boxes filled with dry soil, collected from a field, belonging to Agro Chacon, which previously was used for growing lettuce, were each set up with 15 plants grown in vermiculite and 15 plants grown in processed rice hull material respectively. The boxes were placed in full sun, exposed to very windy conditions and soil temperatures between 22° C. to 26° C. during the next four hours. The plants in box one got water immediately after transplanting. The plants in box two got water after four hours and twenty minutes.

Results: The leaves of the plants in box two had lost nearly all the water pressure at the time of watering. After another hour, the leaves had recovered most of the pressure. The plants in box one looked better. The next day, a difference, although not so dramatic, could still be observed.

The boxes were made from transparent plastic and it was thus possible to study the roots. Surprisingly, a better (more branched) root system with many more root-ends had developed by the plants initially grown in the processed rice hull material. However, no significant differences in the above soil part (stem and leafs) could be observed between plants initially grown in processed rice hull material in comparison with plants initially grown in vermiculite.

Five days after transplantation a small difference of the above soil part of the plants could still be observed.

Finally, a week after transplantation no visible differences between plants initially grown in processed rice hull material could be observed in comparison with plants initially grown in vermiculite. All plants produced white solid tap-roots.

### Example 8

### Comparison between Processed Rice Hull Material and Vermiculite as Filler Material in Germinating Units/Seed Tapes

Seed tapes were prepared comprising filler material made from either vermiculite or processed rice hull material according to the present invention. Seeds of broccoli and lettuce were placed in the filler material. The seed tapes were placed with access to water and the growth were followed.

Result: No differences could be observed between plants irrespective whether they were grown in vermiculite or in processed rice hull material of the present invention. All plants looked vigorous, dark green and had developed a white root system that intermingled very well with the vermiculite or the processed rice hull material. All plants had developed two and a half real leafs and were ready for transplanting. Furthermore, no detectable fungus was observed in either material.

Some of the lettuce plants were transplanted into normal soil. After two days a lot of roots were penetrating into the soil below the germinating units and the plants were able to obtain water and nutrients from the surrounding soil. No difference could be observed between plants initially grown in vermiculite versus rice hull material.

Thus, processed rice hull material is a very appropriate filler material in germinating units/seed tapes and supports the growth of broccoli and lettuce plants equally well as vermiculite.

### Example 9

### Use of Processed Rice Hull Material for Growing a Grass Mat

Processed rice hull material according to the present invention was distributed in a thin layer of 10+ mm, wherein grass seeds were sown and water was added.

Results: At day nine a tight carpet of “grass green” grass had developed. After 4-6 weeks the roots of the grass had developed a network which allowed the grass mats to be moved/rolled. Two days after transplantation to soil the roots from the grass mats had penetrated into the soil.

### Example 10

### Processed Rice Hull Material as an Alternative to Conventional Growth Medium

Processed rice hull material was distributed into half of the 228 wells in a plastic tray (4×50×60 cm, Antonio Zamora). Commercial growth media, peat moss mixed with clay, obtained from Pindstrup, DK was distributed in the other half of the wells. Seeds of broccoli were seeded in all wells. The germination was initiated in house and after three days the trays were placed outside in full sunlight.

Results: All the seeds germinated and seed leaves became visible. This indicates that the processed rice hull material may be used as an alternative to peat moss for plant growing in known systems.

The above description of the invention reveals that it is obvious that it can be varied in many ways. Such variations are not to be considered a deviation from the scope of the invention, and all such modifications which are obvious to persons skilled in the art are also to be considered comprised by the scope of the succeeding claims.

1. A method of preparing a germination and plant growth medium from a rice hull material usable for germination and growth of plants being sensitive to inhibition by allelopathic substances from rice by processing rice hull material to remove allelopathic substances, wherein the rice hull material is washed with an aqueous wash liquid.

2. The method according to claim 1, wherein the allelopathic substances are removed by the washing to obtain the germination and plant growth medium sufficiently devoid of allelopathic substances to be usable as a sole medium for germination and growth of plants being sensitive to inhibition by allelopathic substances from rice.

3. The method according to claim 1, wherein said aqueous wash liquid includes one or more surfactants.

4. The method according to claim 1, wherein said method further comprises a step for heating the rice hull material.

5. The method according to claim 1, wherein said method further comprises a step for dividing the rice hull material before or after the washing thereof.

6. The method according to claim 1, wherein said method further comprises a step for drying the rice hull material subsequent to washing thereof.

7. A method of preparing processed rice hull material according to claim 1, wherein said method comprises the steps:
a. leaving the rice hull material in a aqueous wash liquid;
b. removing the aqueous wash liquid partially or completely; and
c. optionally, dividing the rice hull material.

8. A method of preparing processed rice hull material according to claim 1, wherein said method comprises the steps:
a. moistening the rice hull material by mixing it with an aqueous solution of a surfactant;
b. incubating the mixture;
c. adding further water;
d. washing the resulting mixture by stirring;
e. removing the aqueous wash liquid partially or completely; and
f. optionally, dividing the rice hull material.

9. A method according to claim 1, wherein the medium of processed rice hull material is given a physical form suitable for germination and plant growth selected from a mat, a block, a particulate or granulate, which form may be incorporated in a confined space and/or attached to a carrier tape.

10. A method according to claim 9 wherein the physical form is a mat, comprising the steps of:
a. washing a rice hull material to remove allelopathic substances with an aqueous wash liquid,
b. adding a binder to the washed rice hull material obtained in step a) to form a blend;
c. letting the blend settle on a supporting surface; and
d. optionally heating the blend.

11. The method according to claim 10, wherein the binder is selected from the group consisting of: bi-component fiber, polyvinyl acetate (PVA), water based glue, hot-melt glue and wax.

12. The method according to claim 11, wherein the bi-component fiber is selected from the group consisting of: polylactide (PLA), polyester (PET), polyethylene (PE) and polypropylene (PP).

13. Method according to claim 9, wherein the physical form is a germination and plant growth medium block, comprising the steps:
preparing a germination and plant growth medium mat, comprising the steps a-d:
a. washing a rice hull material to remove allelopathic substances with an aqueous wash liquid,
b. adding a binder to the washed rice hull material obtained in step a) to form a blend;
c. letting the blend settle on a supporting surface;
d. optionally heating the blend;
and then
e. dividing said mat into suitable sized blocks.

14. A method according to claim 9, wherein the physical form is tape, comprising the steps:
preparing a germination and plant growth medium block, comprising the steps a-d:
a. washing a rice hull material to remove allelopathic substances with an aqueous wash liquid,
b. adding a binder to the washed rice hull material obtained in step a) to form a blend;
c. letting the blend settle on a supporting surface;
d. optionally heating the blend;
and then
e. dividing said mat into suitable sized blocks; and
f. attaching the blocks to a carrier strip.

15. A method according to claim 9 including the further step of adding one or more seeds or the like growth-suited parts of a plant, and optionally adjuvants and germination and growth promoters to the given physical form of the processed rice hull material at a suitable step.

16. Method according to claim 15, wherein the addition is carried out during the mat preparation.

17. Method according to claim 15 wherein the addition is carried out to each block after the mat has been divided into suitable sized blocks.

18. Method according to claim 15 wherein the addition is carried out to each block after the blocks have been attached to the carrier strip.

19. Germination and plant growth medium obtained by the method according to claim 1, which medium is sufficiently devoid of allelopathic substances to be usable as a sole medium for germination and growth of plants being sensitive to inhibition by allelopathic substances from rice.

20. Germination and plant growth medium according to claim 19, wherein said rice hull material is selected from divided, whole or essentially whole rice hulls, or a mixture thereof.

21. Germination and plant growth medium according to claim 20, wherein said divided rice hull material has a size between 1 μm and 5 mm.

22. Germination and plant growth medium according to claim 19, wherein the medium of processed rice hull material is in a physical form suitable for germination and plant growth selected from a mat, a block, a particulate or granulate, which form may be incorporated in a confined space and/or attached to a carrier tape.

23. Germination and plant growth medium according to claim 22, wherein the medium further includes one or more seeds or the like growth-suited parts of a plant, and optionally adjuvants and germination and growth promoters.

24. Germination and plant growth medium according to claim 19 in form of a germinating unit which further to the medium include seeds or the like growth-suited parts of a plant, and which are available either separately or coherently in form of seed tapes.

25. Germination and plant growth medium according to claim 19 in form of a seed tape further including successively arranged germinating units attached to at least one carrier strip wherein said units comprises a seed placed in the germination and plant growth medium.

26. Use of a germination and plant growth medium according to claim 19 for the production of plants.

27. Use of a germination and plant growth medium according to claim 19 for the production of germinating units.

28. Use of a germination and plant growth medium according to claim 19 for the production of seed tapes.

29. Use of a germination and plant growth medium according to claim 19 for the production of grass mats.
